(19) United States
(12) Patent Application Publication
(10) Pub. No.: US 2016/0141094 A1
(43) Pub. Date: May 19, 2016

(54) TRANSFORMER AND BOBBIN THEREOF

(71) Applicant: DELTA ELECTRONICS, INC., Taoyuan City (TW)

(72) Inventors: Cheng-En LIAO, Taoyuan City (TW); Yi-Lin CHEN, Taoyuan City (TW); Ming-Cheng LEE, Taoyuan City (TW); Tsai-Sheng LIN, Taoyuan City (TW); Li-Sheng SHIU, Taoyuan City (TW)

(21) Appl. No.: 14/717,481

(22) Filed: May 20, 2015

(30) Foreign Application Priority Data
Nov. 18, 2014 (TW) 103139867

(51) Int. Cl. H01F 27/32; H01F 27/29; H01F 27/04

(52) U.S. Cl. CPC H01F 27/325; H01F 27/04; H01F 27/292; H01F 2027/297

(57) ABSTRACT

A bobbin is provided. The bobbin includes a base, a first pin unit and a second pin unit. The base includes a first surface, a first side and a second side. The first pin unit is connected to the first side. The first pin unit includes a first connection portion. The first connection portion is connected to the base. The first connection portion includes a first enhancing structure. The first enhancing structure protrudes from the first surface, the first enhancing structure includes a first lateral wall. The first lateral wall is connected to the first surface. A first boundary line exists where the first lateral wall is connected to the first surface, and the first boundary line is not a straight line. The second pin unit is connected to the second side.

### CROSS REFERENCE TO RELATED APPLICATIONS

This Application claims priority of Taiwan Patent Application No. 103139867, filed on Nov. 18, 2014, the entirety of which is incorporated by reference herein.

### BACKGROUND OF THE INVENTION

1. Field of the Invention

The present invention relates to a bobbin, and in particular to the bobbin of a transformer.

2. Description of the Related Art

The conventional bobbin of a transformer is formed by plastic material via injection molding, and includes a base and bobbin blades. The bobbin blades are integrally formed on the base. Conventionally, the bobbin blades overlap the base with a large connection area to ensure structural strength between the bobbin blades and the base. However, if the connection area between the bobbin blades and the base is decreased in order to minimize the use of material, the bobbin blades can easily become separated from the base due to any unexpected bending.

### BRIEF SUMMARY OF THE INVENTION

In one embodiment of the invention, a transformer is provided. The transformer includes a first housing, a second housing, a coil, a bobbin, a base, a first pin unit, and a second pin unit. The first housing comprises a magnetic shaft. The coil is surrounding the magnetic shaft. The bobbin is disposed between the first housing and the second housing, and the coil is connected to the bobbin. The bobbin includes a base, a first pin unit, and a second pin unit. The base comprises a first surface, a first side, and a second side. The first pin unit is connected to the first side. The first pin unit comprises a first connection portion. The first connection portion is connected to the base. The first connection portion comprises a first enhancing structure. The first enhancing structure protrudes from the first surface and comprises a first lateral wall. The first lateral wall is connected to the first surface. A first boundary line exists where the first lateral wall is connected to the first surface, and the first boundary line is not a straight line. The second pin unit is connected to the second side.

In one embodiment, the first pin unit comprises a plurality of first pins. The first pin unit comprises a first extending portion. The first extending portion is connected to the first connection portion. Each of the first pins is partially embedded in the first extending portion.

In one embodiment, the first extending portion comprises a first slot.

In one embodiment, the second pin unit comprises a second connection portion. The second connection portion is connected to the base. The second connection portion comprises a second enhancing structure, which protrudes from the first surface. The second enhancing structure comprises a second lateral wall. The second lateral wall is connected to the first surface, and a second boundary line exists where the second lateral wall is connected to the first surface. The second boundary line is not a straight line.

In one embodiment, the second pin unit comprises a plurality of second pins. The second pin unit comprises a second extending portion. The second extending portion is connected to the second connection portion. Each of the second pins is partially embedded in the second extending portion.

In one embodiment, the second extending portion comprises a second slot.

In one embodiment, the first boundary line comprises a curved line, and the second boundary line comprises a curved line.

In one embodiment, the first boundary line comprises a sawtooth line, and the second boundary line comprises a sawtooth line.

In one embodiment of the invention, a bobbin is provided. The bobbin includes a base, a first pin unit, and a second pin unit. The base comprises a first surface, a first side, and a second side. The first pin unit is connected to the first side. The first pin unit comprises a first connection portion. The first connection portion is connected to the base. The first connection portion comprises a first enhancing structure. The first enhancing structure protrudes from the first surface. The first enhancing structure comprises a first lateral wall. The first lateral wall is connected to the first surface. A first boundary line exists where the first lateral wall is connected to the first surface, and the first boundary line is not a straight line. The second pin unit is connected to the second side.

In one embodiment of the invention, the first enhancing structure and the second enhancing structure are curved protrusion structures. The first boundary line comprises a curved line. The second boundary line comprises a curved line. Utilizing the boundary lines of the embodiment of the invention, which are not straight lines, the material usage of the bobbin is decreased (for example, some material is removed from both lateral sides of the first enhancing structure). However, the connection strength between the first pin unit and the base, and the connection strength between the second pin unit and the base are maintained. Therefore, the bobbin of the embodiment reduces cost and weight, and maintains structural strength.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is an assembled view of a transformer of a first embodiment of the invention;

FIG. 1B is an exploded view of the transformer of the first embodiment of the invention;

FIG. 1C is a top view of a bobbin of the first embodiment of the invention;

FIG. 2A is an assembled view of a transformer of a second embodiment of the invention;

FIG. 2B is an exploded view of the transformer of the second embodiment of the invention; and

FIG. 2C is a top view of a bobbin of the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

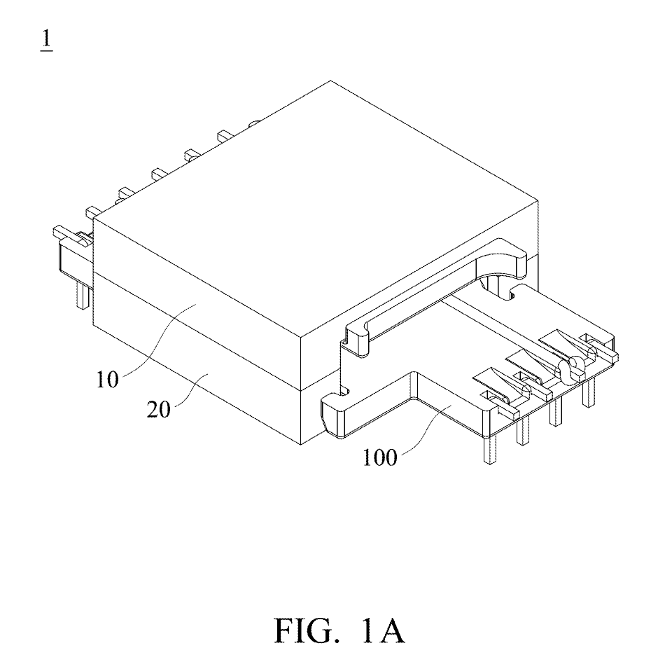

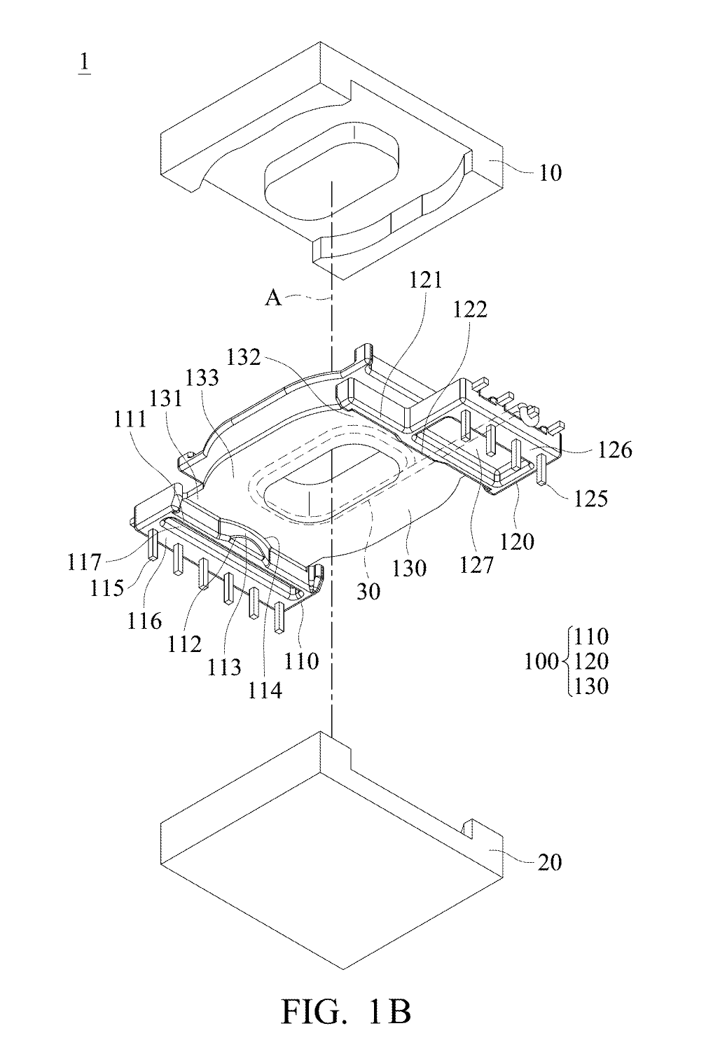

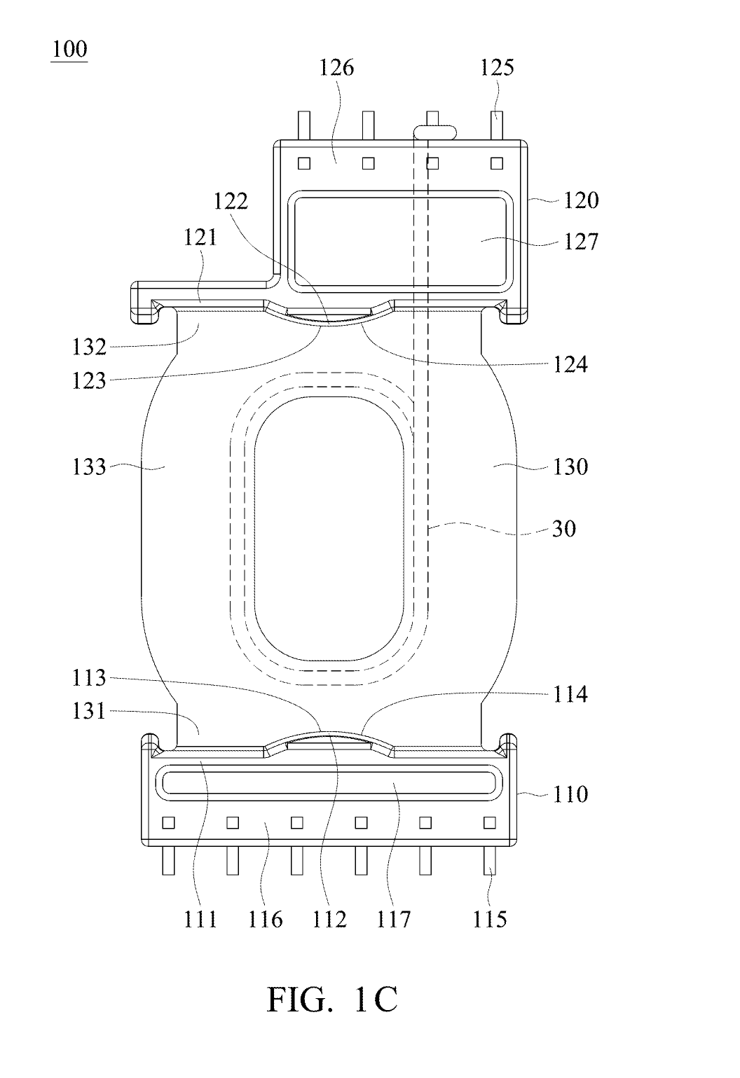

FIGS. 1A and 1B show a transformer 1 of a first embodiment of the invention, including a first housing 10, a second housing 20, a coil 30, and a bobbin 100. The first housing 10 comprises a magnetic shaft A. The coil 30 is surrounding the magnetic shaft A. The bobbin 100 is disposed between the first housing 10 and the second housing 20. The coil 30 is connected to the bobbin 100. The bobbin 100 comprises a base 130, a first pin unit 110, and a second pin unit 120. The base 130 comprises a first surface 133, a first side 131, and a second side 132. The first pin unit 110 is connected to the first side 131. The first pin unit 110 comprises a first connection portion 111. The first connection portion 111 is connected to the base 130. The first connection portion 111 comprises a first enhancing structure 112. The first enhancing structure 112 protrudes from the first surface 133. The first enhancing structure 112 comprises a first lateral wall 113. The first lateral wall 113 is connected to the first surface 133. A first boundary line 114 exists where the first lateral wall 113 is connected to the first surface 133, and the first boundary line 114 is not a straight line. The second pin unit 120 is connected to the second side 132.

In one embodiment, the first connection portion 111 is integrally formed on the base 130.

In one embodiment, the first pin supporting unit 110 comprises a plurality of first pins 115. The first pin supporting unit 110 comprises a first extending portion 116. The first extending portion 116 is connected to the first connection portion 111. Each of the first pins 115 is partially embedded in the first extending portion 116.

In one embodiment, the first extending portion 116 comprises a first slot 117. The first slot 117 reduces the use of material, and decreases the cost and weight of the bobbin.

With reference to FIGS. 1B and 1C, in one embodiment, the second pin unit 120 comprises a second connection portion 121, and the second connection portion 121 is connected to the base 130. The second connection portion 121 comprises a second enhancing structure 122. The second enhancing structure 122 protrudes from the first surface 133. The second enhancing structure 122 comprises a second lateral wall 123. The second lateral wall 123 is connected to the first surface 133, and a second boundary line 124 exists where the second lateral wall 123 is connected to the first surface 133. The second boundary line 124 is not a straight line. In one embodiment, the second connection portion 121 is integrally formed on the base 130.

In one embodiment, the second pin unit 120 comprises a plurality of second pins 125. The second pin unit 120 comprises a second extending portion 126. The second extending portion 126 is connected to the second connection portion 121. Each of the second pins 125 is partially embedded in the second extending portion 126.

In one embodiment, the second extending portion 126 comprises a second slot 127. The second slot 127 lessons the use of material, and decreases the cost and weight of the bobbin.

In the first embodiment, the first enhancing structure 112 and the second enhancing structure 122 are curved protrusion structures. The first boundary line comprises a curved line. The second boundary line comprises a curved line. Utilizing the boundary lines of the embodiment of the invention, which are not straight lines, the material usage of the bobbin 100 is decreased (for example, material is removed from both lateral sides of the first enhancing structure 112). However, the connection strength between the first pin unit 110 and the base 130, and the connection strength between the second pin unit 120 and the base 130 are maintained. Therefore, the bobbin of the embodiment reduces cost and weight, and maintains the structural strength.

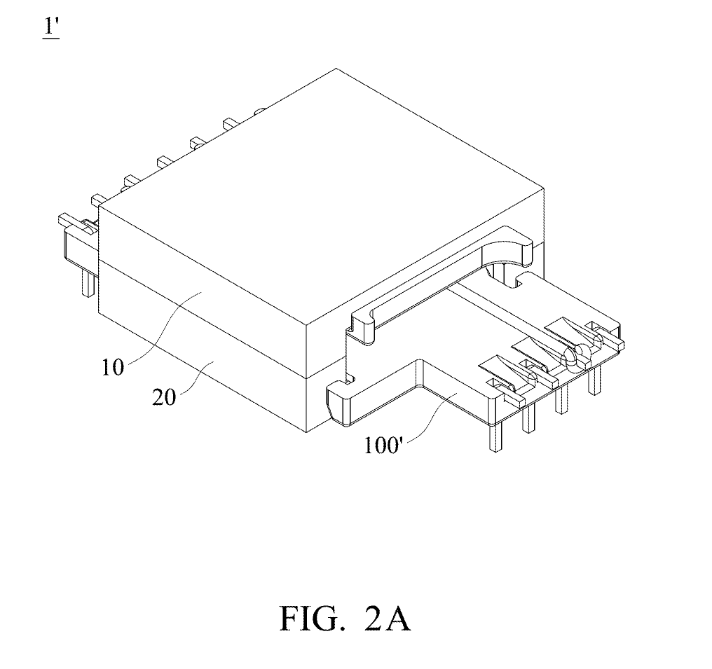

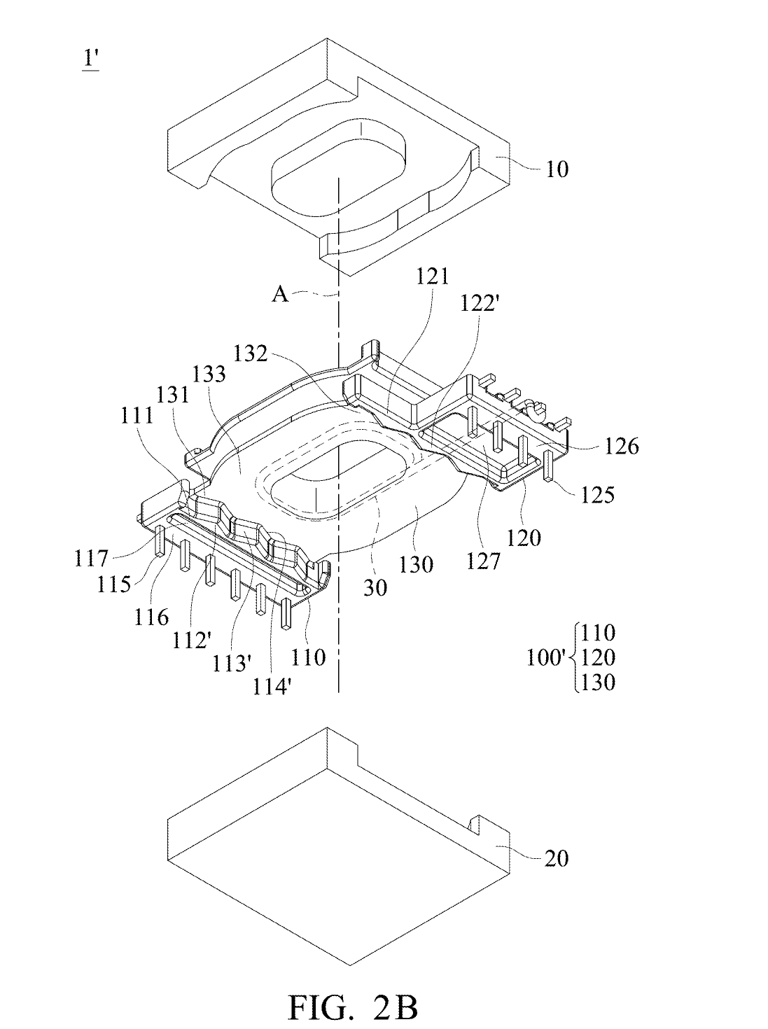

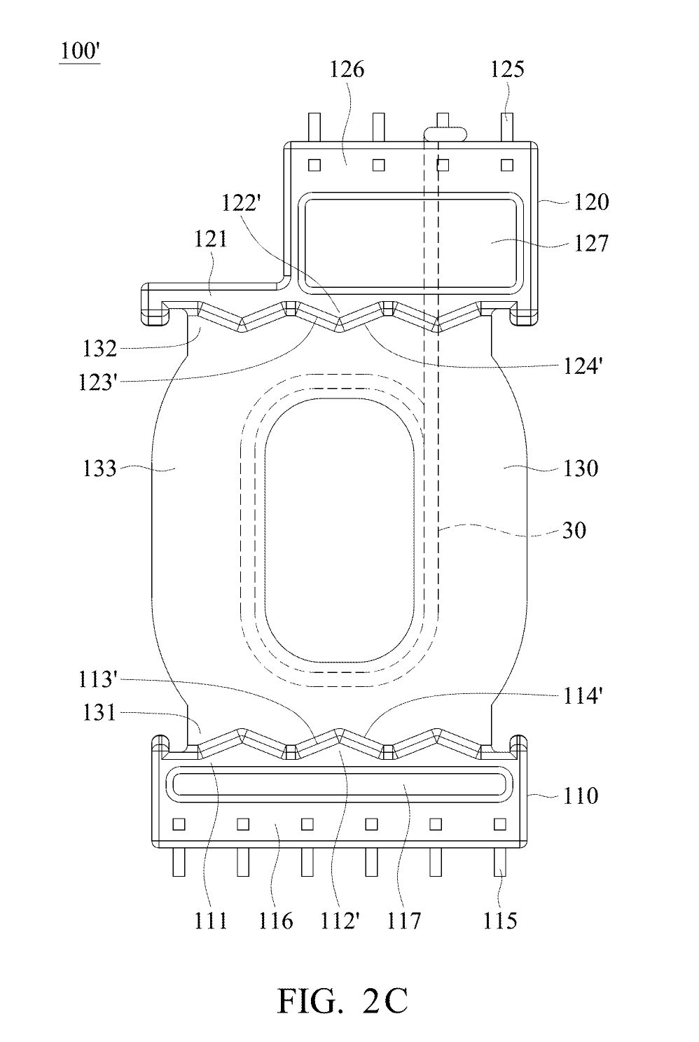

In the first embodiment, the first boundary line and the second boundary line comprise curved lines. However, the embodiment is not meant to restrict the invention. FIGS. 2A and 2B show a transformer 1′ of a second embodiment of the invention, including a first housing 10, a second housing 20, a coil 30 and a bobbin 100′. The first housing 10 comprises a magnetic shaft A. The coil 30 is surrounding the magnetic shaft A. The bobbin 100′ is disposed between the first housing 10 and the second housing 20. The coil 30 is connected to the bobbin 100′. The bobbin 100′ comprises a base 130, a first pin unit 110, and a second pin unit 120. The base 130 comprises a first surface 133, a first side 131, and a second side 132. The first pin unit 110 is connected to the first side 131. The first pin unit 110 comprises a first connection portion 111. The first connection portion 111 is connected to the base 130. The first connection portion 111 comprises a first enhancing structure 112′. The first enhancing structure 112′ protrudes from the first surface 133. The first enhancing structure 112′ comprises a first lateral wall 113′. The first lateral wall 113′ is connected to the first surface 133. A first boundary line 114′ exists where the first lateral wall 113′ is connected to the first surface 133, and the first boundary line 114′ is not a straight line. The second pin unit 120 is connected to the second side 132.

In one embodiment, the first pin unit 110 comprises a plurality of first pins 115. The first pin unit 110 comprises a first extending portion 116. The first extending portion 116 is connected to the first connection portion 111. Each of the first pins 115 is partially embedded in the first extending portion 116.

In one embodiment, the first extending portion 116 comprises a first slot 117. The first slot 117 reduces the use of material, and decreases the cost and weight of the bobbin.

With reference to FIGS. 2B and 2C, in one embodiment, the second pin unit 120 comprises a second connection portion 121, and the second connection portion 121 is connected to the base 130. The second connection portion 121 comprises a second enhancing structure 122′. The second enhancing structure 122′ protrudes from the first surface 133. The second enhancing structure 122′ comprises a second lateral wall 123′. The second lateral wall 123′ is connected to the first surface 133, and a second boundary line 124′ exists where the second lateral wall 123′ is connected to the first surface 133. The second boundary line 124′ is not a straight line.

In one embodiment, the second pin unit 120 comprises a plurality of second pins 125. The second pin unit 120 comprises a second extending portion 126. The second extending portion 126 is connected to the second connection portion 121. Each of the second pins 125 is partially embedded in the second extending portion 126.

In one embodiment, the second extending portion 126 comprises a second slot 127. The second slot 127 minimizes the use of material, and decreases the cost and weight of the bobbin.

In the second embodiment, the first enhancing structure 112′ and the second enhancing structure 122′ are sawtooth-shaped protrusion structures. The first boundary line comprises a sawtooth line. The second boundary line comprises a sawtooth line. Utilizing the boundary lines of the embodiment of the invention, which are not straight lines, the material usage of the bobbin 100′ is decreased (for example, the material is removed from between two adjacent teeth in the sawtooth pattern). However, the connection strength between the first pin unit 110 and the base 130, and the connection strength between the second pin unit 120 and the base 130 are maintained. Therefore, the bobbin of the embodiment reduces cost and weight, and maintains the structural strength.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bobbin, comprising:
a base, comprising a first surface, a first side and a second side;
a first pin unit, connected to the first side, wherein the first pin unit comprises a first connection portion, the first connection portion is connected to the base, the first connection portion comprises a first enhancing structure, the first enhancing structure protrudes from the first surface, the first enhancing structure comprises a first lateral wall, the first lateral wall is connected to the first surface, a first boundary line exists where the first lateral wall is connected to the first surface, and the first boundary line is not a straight line; and
a second pin unit, connected to the second side.

2. The bobbin as claimed in claim 1, wherein the first boundary line comprises a sawtooth line.

3. The bobbin as claimed in claim 1, wherein the first boundary line comprises a curved line.

4. The bobbin as claimed in claim 1, wherein the first pin unit comprises a plurality of first pins.

5. The bobbin as claimed in claim 4, wherein the first pin unit comprises a first extending portion, the first extending portion is connected to the first connection portion, and each of the first pins is partially embedded in the first extending portion.

6. The bobbin as claimed in claim 5, wherein the first extending portion comprises a first slot.

7. The bobbin as claimed in claim 1, wherein the second pin unit comprises a second connection portion, the second connection portion is connected to the base, the second connection portion comprises a second enhancing structure, the second enhancing structure protrudes from the first surface, the second enhancing structure comprises a second lateral wall, the second lateral wall is connected to the first surface, a second boundary line exists where the second lateral wall is connected to the first surface, and the second boundary line is not a straight line.

8. The bobbin as claimed in claim 7, wherein the second boundary line comprises a sawtooth line.

9. The bobbin as claimed in claim 7, wherein the second boundary line comprises a curved line.

10. The bobbin as claimed in claim 7, wherein the second pin unit comprises a plurality of second pins.

11. The bobbin as claimed in claim 10, wherein the second pin unit comprises a second extending portion, the second extending portion is connected to the second connection portion, and each of the second pins is partially embedded in the second extending portion.

12. The bobbin as claimed in claim 11, wherein the second extending portion comprises a second slot.

13. A transformer, comprising:
a first housing, comprising a magnetic shaft;
a second housing;
a coil, surrounding the magnetic shaft; and
a bobbin, disposed between the first housing and the second housing, the coil is connected to the bobbin, wherein the bobbin comprises:
a base, comprising a first surface, a first side and a second side;
a first pin unit, connected to the first side, wherein the first pin unit comprises a first connection portion, the first connection portion is connected to the base, the first connection portion comprises a first enhancing structure, the first enhancing structure protrudes from the first surface, the first enhancing structure comprises a first lateral wall, the first lateral wall is connected to the first surface, a first boundary line exists where the first lateral wall is connected to the first surface, and the first boundary line is not a straight line; and
a second pin unit, connected to the second side.

14. The transformer as claimed in claim 13, wherein the first boundary line comprises a sawtooth line.

15. The transformer as claimed in claim 13, wherein the first boundary line comprises a curved line.

16. The transformer as claimed in claim 13, wherein the first pin unit comprises a plurality of first pins.

17. The transformer as claimed in claim 16, wherein the first pin unit comprises a first extending portion, the first extending portion is connected to the first connection portion, and each of the first pins is partially embedded in the first extending portion.

18. The transformer as claimed in claim 17, wherein the first extending portion comprises a first slot.
